(19) United States
(12) Patent Application Publication
(10) Pub. No.: US 2010/0272701 A1
(43) Pub. Date: Oct. 28, 2010

(54) METHOD FOR PRODUCING BACTERICIDE OR SOIL CONDITIONER CONTAINING BACILLUS SUBTILIS

(75) Inventor: LIANG-JUNG CHEN, MAOLI COUNTY (TW)

Correspondence Address: Liang-Jung Chen, 5F, NO.6 Ke-dong Rd, Sec. 3, Science-based industrial Park, Jhunan Township, TW

(73) Assignee: BION TECH INC., MAOLI COUNTY (TW)

(21) Appl. No.: 11/624,074

(22) Filed: Jan. 17, 2007

(51) Int. Cl. A01N 63/02; A01P 1/00; C05F 11/08

(52) U.S. Cl. 424/93.462; 71/6

(57) ABSTRACT

The present invention provides a method for producing bactericide or soil conditioner containing Bacillus subtilis which is primarily implementing a mixture of starch, protein, molasses, yeast powder, corn steep liquor, (NH₄)₂SO₄, K₂HPO₄, MgSO₄.7H₂O, CaCl₂.2H₂O and MnSO₄.H₂O as a culture medium and composed of the steps including choosing bacterial species, preparing culture medium, fermentation treatment, vacuum concentration, preparing liquid preparation, spray dryness, preparing powdery preparation and preparing other forms of preparation. A culture solution made through the disclosed method can be applied as bactericide or soil conditioner which can be produced in the form of liquid preparation or powdery preparation and can be applied to plants, soil and seed to present excellent effect on control of bacterial wilt.

### BACKGROUND OF THE INVENTION

1. Field of the Invention

The present invention relates to a method for producing bactericide or soil conditioner containing Bacillus subtilis, and more particularly, to a method about cultivating Bacillus subtilis in a culture medium to form a culture solution and subsequently processing the culture solution into liquid or powdery bactericide or soil conditioner. As the finished bactericide functions on the strength of biological means, the same is also referred to as biocontrol.

2. Description of the Prior Art

Bacillus subtilis is a type of spore-yielding fungus and is versatile for the isolates thereof are generally used for producing enzyme or antibiotics. Distinctively, the present invention is related to implementing such Bacillus subtilis to produce bactericide or soil conditioner and discloses that the spores and metabolic substances derived from cultivated special isolates can function as pesticide against plant diseases (such as pea powdery mildew) and ameliorate soil bacterial flora for benefiting plant growth.

### SUMMARY OF THE INVENTION

The present invention herein disclosed provides a method for producing bactericide or soil conditioner containing Bacillus subtilis which involves cultivating a particular sort of Bacillus subtilis isolates in fermentation tanks with a specially formulated culture medium and under a predetermined operation condition until sporulation, vacuum concentrating the resultant culture solution for demoisturization and properly preparing the concentrated culture solution into liquid bactericide or soil conditioner. Alternatively, spray dryness may be subsequently carried out to foresaid concentrated culture solution and the resultant powder can be properly prepared into powdery bactericide or soil conditioner. Moreover, other forms (tablet or emulsion) of bactericide or soil conditioner can be derivatively realized through further processing said liquid or powdery preparation.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic flow chart illustrating the method for producing bactericide or soil conditioner containing Bacillus subtilis of the present invention.

### DESCRIPTION OF THE PREFERRED EMBODIMENT

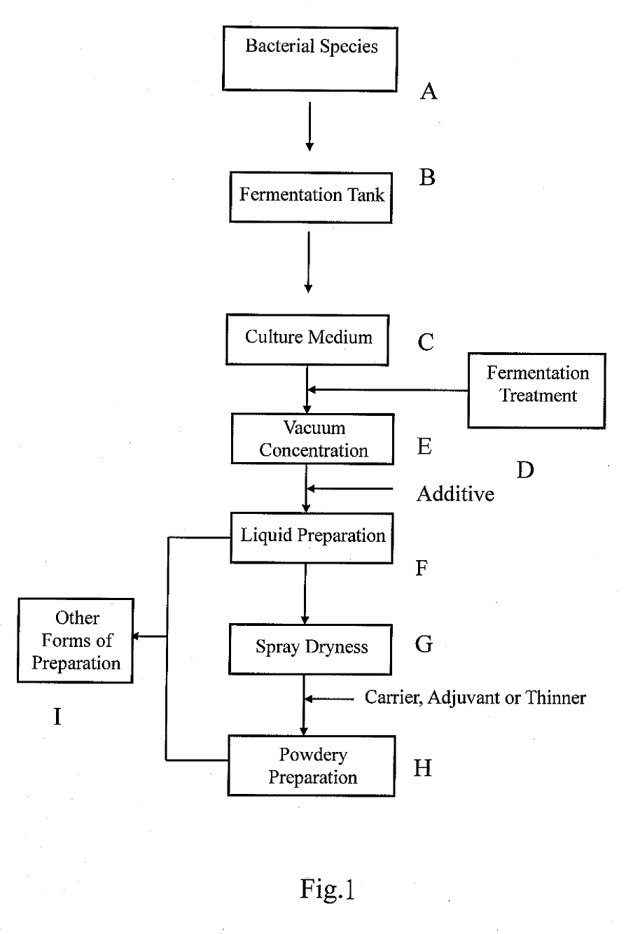

The present invention provides a method for producing bactericide or soil conditioner containing Bacillus subtilis which is primarily implementing a mixture of starch, protein, molasses, yeast powder, corn steep liquor, (NH₄)₂SO₄, K₂HPO₄, MgSO₄.7H₂O, CaCl₂.2H₂O and MnSO₄.H₂O as a culture medium and composed of following steps which can be seen in FIG. 1.

### 1. Bacterial Species A:

Choose proper Bacillus subtilis isolates applicable to the production of bactericide or soil conditioner. The said isolates can be purchased on the market. For the purpose of the present invention, isolates of BCRC 14199, 10259, 10258 and 10257 are obtained from Bioresource Collection Research Center (BCRC) of Food Industry Research and Development Institute of Taiwan.

### 2. Fermentation Tank B:

As Bacillus subtilis is aerobic, the growth thereof requires macrophage oxygen and in the disclosed method, the liquid fermentation treatment for cultivating Bacillus subtilis is preferably conducted in fermentation tanks B of stirred aerated type or some other type supplying equivalently high oxygen intensity. In the present invention, large-sized industrial stirred aerated fermentation tanks with the capacity varued from 50 liters to 50000 liters (50 tons) are exemplificatively applied for cultivating Bacillus subtilis while fermentation tanks with an alternative capacity range are also applicable.

### 3. Culture Medium C:

The C/N ratio and concentration of other micronutrient of the culture medium C applied in the present invention have been determined after optimization for advancing balanced growth of Bacillus subtilis and yield of spores and metabolic substances thereof. The optimal culture medium C has the following proportional composition: 5 grams of starch: 3 grams of protein: 1 gram of molasses: 1.5 grams of yeast powder: 0.5 grams of corn steep liquor: 0.3 grams of (NH₄)₂SO₄: 0.4 grams of K₂HPO₄: 0.2 grams of MgSO₄.7H₂O: 10 milligrams of CaCl₂.2H₂O: 6 milligrams of MnSO₄.H₂O.

The preferable culture medium C prepared for cultivating Bacillus subtilis has a composition range of starch varying from 5 to 40 g/L, protein varying from 3 to 24 g/L, molasses varying from 1 to 8 g/L, yeast powder varying from 1.5 to 12.0 g/L, corn steep liquor varying from 0.5 to 4.0 g/L, (NH₄)₂SO₄ varying from 0.3 to 2.4 g/L, K₂HPO₄ varying from 0.4 to 3.2 g/L, MgSO₄.7H₂O varying from 0.2 to 1.6 g/L, CaCl₂.2H₂O varying from 10 to 80 mg/L and MnSO₄.H₂O varying from 6 to 48 mg/L. Growth retardation may be induced onto Bacillus subtilis if the culture medium possesses concentration lower than foregoing composition range while growth inhibition may be induced onto Bacillus subtilis if the culture medium possesses concentration higher than foregoing composition range

A more preferable composition range with respect to the culture medium C facilitating fast growth of Bacillus subtilis contains starch varying from 15 to 30 g/L, protein varying from 9 to 18 g/L, molasses varying from 3 to 6 g/L, yeast powder varying from 4.5 to 9.0 g/L, corn steep liquor varying from 1.5 to 3.0 g/L, (NH₄)₂SO₄ varying from 0.9 to 1.8 g/L, K₂HPO₄ varying from 1.2 to 2.4 g/L, MgSO₄.7H₂O varying from 0.6 to 1.2 g/L, CaCl₂.2H₂O varying from 30 to 60 mg/L and MnSO₄.H₂O varying from 18 to 36 mg/L.

A most preferable composition range with respect to the culture medium C facilitating fast growth of Bacillus subtilis according to the present invention contains starch varying from 20-25 g/L, protein varying from 12-15 g/L, molasses varying from 4 to 5 g/L, yeast powder varying from 6.0 to 7.5 g/L, corn steep liquor varying from 2.0 to 2.5 g/L, (NH₄)₂SO₄ varying from 1.2 to 1.5 g/L, K₂HPO₄ varying from 1.6 to 2.0 g/L, MgSO₄.7H₂O varying from 0.8 to 1.0 g/L, CaCl₂.2H₂O varying from 40 to 50 mg/L and MnSO₄.H₂O varying from 24 to 30 mg/L.

Applicable starch in the present invention can be cornstarch, wheat starch, rice starch or cassava starch. Applicable protein in the present invention can be soy protein, casein or whey protein. No significant difference of effect is observed from implementing varied kinds of starch or protein. Yeast powder should be an essential ingredient of the culture medium C for it provides the necessary growth factor to help Bacillus subtilis yielding spores and metabolic substances. Bacillus subtilis cultivated in a culture medium lacking for yeast powder has poor development and is therefore inadequate for manufacturing bactericide or soil conditioner. Though molasses, yeast powder and corn steep liquor inherently contain little micronutrient, a supplement of inorganic salts is necessary for the culture medium C of the present invention for.

### 4. Fermentation Treatment D

In the present invention, experiments has been devised to substantiate that the maximum output of Bacillus subtilis spores and metabolic substances can be achieved by way of fermentation treatment with the optimal culture medium C carried out under a given operation condition, as will be explained below.

Preferably, the culture medium C occupies at most 70% of the capacity of the fermentation tank B so as to accommodate the foam formed at the surface of the culture medium C and prevent the culture medium C from spilling out during stirring. The culture medium C is sterilized with saturated steam at 121° C. for the duration varied subject to the capacity of the fermentation tank B. However, to avoid possible denaturation of the culture medium C caused by excessively prolonged heating, the duration should be minimized to the shortest possible period. The proposed duration for sterilizing the culture medium C at 121° C. of the present invention is lass than 20 minutes for a 50-liter fermentation tank B, lass than 25 minutes for a 500-liter fermentation tank and lass than 40 minutes for a 5-ton fermentation tank. During the steam sterilization of the culture medium C, the relevant procedures such as steam introducing, heating, temperature maintaining, temperature quenching, water cooling, aerating, and valve controlling may be automatically conducted by a controlling computer pertained to the fermentation tanks B.

In the present invention, Bacillus subtilis spores taken out from a petri dish at 4° C. without the need of heat shock activation are cultivated into culture using shake flask method or fermentation method carried out in a small fermentation tank B for being subsequently transferred into a large industrial fermentation tank.

A preferable operation temperature for the fermentation treatment D is between 20-40° C. while growth retardation of Bacillus subtilis may occur at an operation temperature beyond said range. Meanwhile, the operation temperature is more preferably between 24-36° C. and most preferably between 28-32° C. It is preferable that the operation temperature for the fermentation treatment D is kept between 30-32° C. during the sporulation phase.

The culture solution is now referred to the fermentation broth and with the pH thereof adjusted to between 5.5-8.5 with sterilized acid and alkaline liquid (such as sulfuric acid and sodium hydroxide) for benefiting the fermentation treatment. A pH value outside of this range can render growth inhibition of Bacillus subtilis. The pH value of the fermentation broth for fast growth of Bacillus subtilis is more preferably ranged from 6.0 to 8.0 and is most preferably ranged from 6.5 to 7.5. During the growth process of Bacillus subtilis, the pH value of the fermentation broth depresses throughout the lag phase to the middle period of the vegetative growth phase and the introduction of the alkaline liquid thereto is required while the pH value recovers throughout the middle period of the vegetative growth phase to the sporulation phase and the introduction of the acid liquid thereto is required for keeping the pH with said adjusted range.

The dissolved oxygen (DO) saturation of the fermentation broth shall be preferably maintained above 30% otherwise growth inhibition and bacteriolysis of Bacillus subtilis can be incurred. The DO saturation for fast growth of Bacillus subtilis is more preferably over 50% and most preferably over 70%. During the growth process of Bacillus subtilis, the DO depresses throughout the lag phase to the middle period of the vegetative growth phase and rises throughout the middle period of the vegetative growth phase to the sporulation phase in harmony with the variation of the pH value. The DO saturation can be modulated by varying the stirring rate and/or aeration in the manner that the augmented stirring rate and/or aeration effect the enlarged DO saturation while the abated stirring rate and/or aeration effect the reduced DO saturation.

For maximizing the DO saturation of the fermentation broth, the fermentation tank B is preferably operated at the highest stirring rate which is subject to the capacity of the fermentation tank B. The applied stirring rate may be 80% of the maximum allowable stirring rate recited in the operation instruction of the fermentation tank (if the stirring rate is adjustable) or may be a given stirring rate preprogrammed at the fermentation tank B. For instance, a 50-liter fermentation tank may be operated at 300 rpm; a 500-liter fermentation tank may be operated at 100 rpm; and a 5-ton fermentation tank may be operated at 20 rpm. The strong shearing stress coming along with high-speed stirring can separate cell clusters constructed from head-tail connecting cells into single cells while bring no detrimental effect to the bacterial growth.

When the fermentation tanks B are operated at said stirring rates, aeration with filtered and sterilized air can be modulated by means of the controlling computer pertained to the fermentation tanks B preprogrammed with a minimum DO saturation of the fermentation broth. During the growth process of Bacillus subtilis, the aeration is increased for upholding the DO saturation over the minimum value throughout the lag phase to the middle period of the vegetative growth phase and is depressed throughout the middle period of the vegetative growth phase to the sporulation phase in harmony with the variation of the pH value. When the large fermentation tank is implemented, the full aeration capacity thereof may be employed if necessary to cater for the maximum bacterial oxygen demand happened in the middle period of the vegetative growth phase for overcoming the limitation of the stirring rate.

During the fermentation treatment, as protein contained in the culture medium goes through stirring and aerating, macrophage foam can consequently occur at the surface of the fermentation broth and an automatic antifoam device loaded with sterilized antifoam agent shall be started to eliminate the foam wherein the antifoam agent may be silicon-based substances or lard and be appropriately diluted.

The fermentation treatment can be terminated at the point where 80-95% of the cultivated bacterial cells are releasing free mature spores after lysis thereof. A higher sporulation rate can be time-consuming yet inaccessible and therefore indicates futile operation of the fermentation tank. The entire operation term of the fermentation treatment can be varied from different sizes of the fermentation tanks B. In the present invention, a proposed operation term is less than 20 hours for the 50-liter fermentation tank B; less than 23 hours for the 500-liter fermentation tank B; less than 25 hours for the 5-ton fermentation tank B and less than 26 hours for the 50-ton fermentation tank B.

### 5. Vacuum Concentration E:

Vacuum concentration E is conducted following the fermentation treatment for demoisturizing the finished fermentation broth, i.e. the resultant culture solution. To operate the vacuum concentrator, the vacuum is preferably at 0.5 atm; more preferably under 0.1 atm, and most preferably under 0.01 atm while the boiling point of the culture solution is preferably under 60° C., more preferably under 40° C., and most preferably under 35° C. Such demoisturization results in rising osmotic pressure of the culture solution and facilitates keeping freshness and extending shelf-life thereof.

### 6. Liquid Preparation F:

The concentrated culture solution obtained in Step E can be further prepared as liquid preparation by adding proper amount of proper additive to adjust the moisture content thereof and match the spore density with a predetermined product standard. The applicable additives include at least preservative and acid or alkaline liquid for modulating pH fluctuations. Thereby, the liquid preparation can be applied as bactericide or soil conditioner.

### 7. Spray Dryness G:

The concentrated culture solution obtained through foresaid vacuum concentration E is now completely dehydrated by using a spray dryer. The outlet air temperature of the spray nozzle should be kept under 70° C. to ensure the activity of the spores.

### 8. Powdery Preparation H:

The resultant powder obtained in the step of Spray Dryness G can be further prepared as a powdery preparation by adding proper amount of proper carrier, adjuvant or thinner for matching the spore density with a predetermined product standard. The applicable carrier adjuvant or thinner includes at least wood flour, clay powder and dispersing surfactant. Thereby, the powdery preparation can be applied as bactericide or soil conditioner.

### 9. Other Forms of Preparation I:

Additional forms of preparation such as pastille or emulsion can be obtained by derivatively processing the liquid or powdery preparation.

### Embodiment 1

### Method for Cultivating Bacillus subtilis

Bacillus subtilis spores taken from a PDA dish at 4° C. are activated by shake flask method which is implementing a shake flask with bottom baffles for enhancing oxygen diffusion and stirring effect. The culture medium in the shake flask (hereinafter referred to as the “standard culture medium”) is composed by the proportion of 20 g/l of cornstarch, 12 g/l of soy protein, 4 g/l of molasses, 6 g/l of yeast powder, 2 g/l of corn steep liquor, 1.2 g/l of (NH₄)₂SO₄, 1.6 g/l of K₂HPO₄, 0.8 g/l of MgSO₄.7H₂O, 40 mg/l of CaCl₂.2H₂O and 24 mg/l of MnSO₄.H₂O. The culture medium may preferably fill approximately one-fifth of the capacity of the shake flask; i.e. 100 ml of culture medium for a 500-ml shake flask. Then the shake flask is put into an incubator at 31±1° C. and 200 rpm.

When the Bacillus subtilis in the culture medium reaches the point where the optical density (OD or Absorbance) is at 0.5, the culture solution is ready to be transferred to a 5-liter fermentation tank containing 3.5 liters of standard culture medium for large scale cultivation. Sufficient amount of Bacillus subtilis shall be inoculated into the fermentation tank to obtain a 10% inoculation rate. Then the 5-liter fermentation tank is operated at 31±1° C., pH 7.0±0.1 and 70% DO saturation whereupon the stirring rate of the fermentation tank is over 600 rpm and the aeration is over 1 liter per minute.

When the OD of the Bacillus subtilis in the 5-liter fermentation tank reaches 0.5, the culture solution is ready to be further transferred to a 50-liter fermentation tank containing 35 liters of standard culture medium for subsequent large scale cultivation. Then the 50-liter fermentation tank is operated at 31±1° C., pH 7.0±0.1 and 70% DO saturation whereupon the stirring rate of the fermentation tank is over 300 rpm and the aeration is over 5 liters per minute. The fermentation treatment can proceed until the nutrients in the culture medium are exhausted (it takes about 20 hours after inoculation) when the cultivated cells yield and release mature spores. The culture solution can be further processed with vacuum concentration. Alternatively, the fermentation treatment can proceed until the OD of the Bacillus subtilis in the 50-liter fermentation tank reaches 0.5 so as to provide the product as culture for further fermentation treatment in a 500-liter fermentation tank.

When the OD of the Bacillus subtilis in the 50-liter fermentation tank reaches 0.5, the culture solution is ready to be transferred into a 500-liter fermentation tank containing 350 liters of standard culture medium for advanced large scale cultivation. Then the 500-liter fermentation tank is operated at 31±1° C., pH 7.0±0.1 and 60% DO saturation whereupon the stirring rate of the fermentation tank is over 100 rpm and the aeration is over 15 liters per minute. The fermentation treatment can proceed until the nutrients in the culture medium are exhausted (it takes about 23 hours after inoculation) when the cultivated cells yield and release mature spores. The culture solution can be further processed with vacuum concentration. Alternatively, the fermentation treatment can proceed until the OD of the Bacillus subtilis in the 500-liter fermentation tank reaches 0.5 so as to provide the product as culture for further fermentation treatment in a 5000-liter (5-ton) fermentation tank.

When the OD of the Bacillus subtilis in the 500-liter fermentation tank reaches 0.5, the culture solution is ready to be transferred into a 5000-liter fermentation tank containing 3500 liters of standard culture medium for advanced large scale cultivation. Then the 5000-liter fermentation tank is operated at 31±1° C., pH 7.0±0.1 and 50% DO saturation whereupon the stirring rate of the fermentation tank is over 50 rpm and the aeration is over 30 liters per minute. The fermentation treatment can proceed until the nutrients in the culture medium are exhausted (it takes about 25 hours after inoculation) when the cultivated cells yield and release mature spores. The culture solution can be further processed with vacuum concentration. Alternatively, the fermentation treatment can proceed until the OD of the Bacillus subtilis in the 5000-liter fermentation tank reaches 0.5 so as to provide the product as culture for further fermentation treatment in a 50000-liter (50-ton) fermentation tank.

When the OD of the Bacillus subtilis in the 5000-liter fermentation tank reaches 0.5, the culture solution is ready to be transferred into a 50000-liter fermentation tank containing 35000 liters of standard culture medium for advanced large scale cultivation. Then the 50000-liter fermentation tank is operated at 31±1° C., pH 7.010.1 and 50% DO saturation whereupon the stirring rate of the fermentation tank is over 20 rpm and the aeration is over 50 liters per minute. The fermentation treatment can proceed until the nutrients in the culture medium are exhausted (it takes about 26 hours after inoculation) when the cultivated cells yield and release mature spores. The culture solution can be further processed with vacuum concentration.

### Embodiment 2

### Method for Producing the Culture Solution into Bactericide or Soil Conditioner Containing Bacillus subtilis

All the batches of culture solution fermented in the fermentation tanks as described in Embodiment 1 are demoisturized with a vacuum concentrator operated at a vacuum under 0.1 atm while the boiling point of the culture solution is under 35° C. The possible remained nutrients can be concentrated together with the culture solution and compounded into organic fertilizer for applying to the field and fertilizing the crops. Simultaneously, such arrangement helps for avoiding environmental pollution caused by discharge of the waste culture solution with remained nutrients outside factories.

The concentrated liquid as previously discussed can be prepared as liquid preparation by adding proper amount of water and acid or alkaline liquid to modulate the spore density to over 10⁹/ml and the pH value at 7.0±0.5.

The concentrated culture solution can be alternatively prepared as powdery preparation by using a spray dryer with the outlet air temperature of the spray nozzle under 70° C. and adding a proper amount of clay powder to modulate the to over 10⁹/g.

### Embodiment 3

### Field Experimentation on Liquid Bactericide or Soil Conditioner Containing Bacillus subtilis

The liquid preparation obtained in Embodiment 2 is diluted with water to 400 or 800 times and added with a proper amount of dispersing surfactant. The activation of the Bacillus subtilis spores can be enhanced by mixing the liquid preparation with a fertilizer-grade amino acid liquid diluted to 1000 times and resting the mixture aside for 3 hours. To evenly spray the diluted mixture onto the stems and leaves of pea shoots in the early stage of powdery mildew with an application rates over 200 liters per are by applying once every 7 days for at least 4 times continuously helps prevention and cure of powdery mildew and contributes to vigorous growth, extended fruiting phase as well as gigantic and beautiful fruits of the objective plants. The experimentation is explained in more detail below.

### BionTech Inc.

### Field Experimentation Report June 1995

I. Experimental objectives and purpose investigating into the control effects of the liquid bactericide or soil conditioner containing 4% of Bacillus subtilis (S) against pea powdery mildew
II. Experimental Bactericide: Bacillus subtilis 4% S
III. Experimental Design
1. Experimental Unit: Department of Technical Popularization, BionTech Inc.
2. Experimental Period: Through April 1995 to May 1995
3. Experimental Place: Sinshe, Taichung County
4. Experimental Crops: Pea
5. Experimental Method: Evenly spraying the experimental bactericide onto the experimental crops in the early stage of powdery mildew once every 7 days for 4 times.
6. Farmland layout: Adopting randomized complete block design, 40 plants in each plot with three replications
7. Bactericide Treatment
A. Bacillus subtilis 4% S 400×
B. Bacillus subtilis 4% S 800×
C. Penconazole 10.5% 1500×
D. No bactericide applied in Control Area
8. Date of Bactericide Application
A. Apr. 16, 1995
B. Apr. 23, 1995
C. Apr. 30, 1995
D. Apr. 7, 1995
9. Date of Observation: May 14, 1995
10. Observation of Control Effect: Observation is conducted one week later after the last application of bactericide to tabularize the statistics of diseased plants and observe fruit setting.

| Experimental Bactericide | Dilution Rate | Morbidity |
|---|---|---|
| Bacillus subtilis 4% S | 400X | 4.9 |
| Bacillus subtilis 4% S | 800X | 6.8 |
| Penconazole 10.5% | 1500X | 3.2 |
| Control Area | | 25.6 |

VI. Experimental Results
Plants in Bacillus subtilis applied area grow vigorously and the fruiting phase lasts over 2 months (through early May to early July) while present gigantic and beautiful fruits (emerald and glossy).
V. Conclusion
1. No phytotoxicity occurs during the Experimentation.
2. It is learned through foregoing statistics data that Bacillus subtilis 4% S presents excellent effect in prevention and cure of pea powdery mildew and contributes to vigorous growth, extended fruiting phase as well as gigantic and beautiful fruits of the objective plants.

### Embodiment 4

### Field Experimentation on Powdery Bactericide or Soil Conditioner Containing Bacillus subtilis

The liquid preparation obtained in Embodiment 2 is diluted with water to 600 times. The activation of the Bacillus subtilis spores can be enhanced by mixing the liquid preparation with a fertilizer-grade amino acid liquid diluted to 1000 times and resting the mixture aside for 3 hours. Pouring the diluted mixture by every plant about 500 ml into the soil around the roots of tomato plants that has been transplanted for 10 days by applying once every 7 days for at least 4 times continuously helps prevention and cure of tomato bacterial wilt and contributes to vigorous growth, extended fruiting phase as well as gigantic and beautiful fruits of the objective plants. The experimentation is explained in more detail below.

### BionTech Inc.

### Field Experimentation Report October 2001

I. Experimental objectives and purpose: investigating into the control effects of the wettable powder bactericide or soil conditioner containing 50% of Bacillus subtilis (WP) against tomato bacterial wilt
II. Experimental Bactericide: Bacillus subtilis 50% WP
III. Experimental Design
1. Experimental Unit: Department of Technical Popularization, BionTech Inc.
2. Experimental Period: Through July 2001 to August 2001
3. Experimental Place: Puli, Nantou County
4. Experimental Crops: Tomato
5. Experimental Method: pouring the Experimental Bactericide into the soil around the corps that has been transplanted for 10 days by applying once every 7 days for at least 4 times continuously
6. Farmland layout: Adopting Randomized Complete Block Design, 50 plants in each plot with three replications
7. Bactericide Treatment
A. Bacillus subtilis 50% WP 600×
B. Cupric Hydroxide 77% WP 800×
C. No bactericide applied in Control Area
8. Date of Bactericide Application
A. Jul. 10, 2001
B. Jul. 17, 2001
C. Jul. 24, 2001
D. Jul. 31, 2001
9. Date of Observation
A. Jul. 17, 2001
B. Jul. 24, 2001
C. Jul. 31, 2001
D. Aug. 6, 2001
E. Aug. 13, 2001
F. Aug. 20, 2001
10. Observation of Control Effect: Observation is conducted after each application to tabularize the statistics of diseased plants and observe fruit setting.
IV. Experimental Results
1. The first two observations show no diseased plant and are not tabularized. It is observed that plants in Bacillus subtilis applied area grow vigorously.
2. The third Observation on diseased plants (Jul. 31, 2001)

| | Morbidity | | | |
|---|---|---|---|---|
| Treatment | 1 | 2 | 3 | average |
| A. Bacillus subtilis 50% WP 600X | 0 | 0 | 0 | 0 |
| B. Cupric Hydroxide 77% WP 800X | 0 | 2 | 0 | 0.66 |
| C. Control Area | 3 | 5 | 3 | 3.66 |

Note:
Plants in Bacillus subtilis applied area grow vigorously.

3. The fourth Observation on diseased plants (Aug. 6, 2001)

| | Morbidity | | | |
|---|---|---|---|---|
| Treatment | 1 | 2 | 3 | average |
| A. Bacillus subtilis 50% WP 600X | 1 | 0 | 0 | 0.33 |
| B. Cupric Hydroxide 77% WP 800X | 4 | 4 | 5 | 4.33 |
| C. Control Area | 5 | 8 | 7 | 6.67 |

Note:
Plants in Bacillus subtilis applied area grow vigorously and yield gigantic and beautiful fruits (colorful and bright).

4. The fifth Observation on diseased plants (Aug. 13, 2001)

| | Morbidity | | | |
|---|---|---|---|---|
| Treatment | 1 | 2 | 3 | average |
| A. Bacillus subtilis 50% WP 600X | 1 | 2 | 0 | 1.00 |
| B. Cupric Hydroxide 77% WP 800X | 8 | 6 | 7 | 7.00 |
| C. Control Area | 7 | 12 | 12 | 10.33 |

Note:
Plants in Bacillus subtilis applied area grow vigorously and yield gigantic and beautiful fruits (colorful and bright).

5. The sixth Observation on diseased plants (Aug. 31, 2001)

| | Morbidity | | | |
|---|---|---|---|---|
| Treatment | 1 | 2 | 3 | average |
| A. Bacillus subtilis 50% WP 600X | 2 | 2 | 1 | 1.67 |
| B. Cupric Hydroxide 77% WP 800X | 10 | 8 | 9 | 9.00 |
| C. Control Area | 11 | 16 | 15 | 14.00 |

Note:
Plants in Bacillus subtilis applied area grow vigorously and yield gigantic and beautiful fruits (colorful and bright).

V. Conclusion:
1. No phytotoxicity occurs during the experimentation.
2. It is learned through foregoing statistics data that Bacillus subtilis 50% WP presents excellent effect in prevention and cure of tomato bacterial wilt and contributes to vigorous growth, extended fruiting phase (Harvesting period lasting from early August to at least November, the average flowering frequency is over of 8 times) as well as gigantic and beautiful fruits (colorful and bright) of the objective plants.

What is claimed is:

1. A method for producing bactericide or soil conditioner containing Bacillus subtilis, which is primarily implementing a mixture of starch, protein, molasses, yeast powder, corn steep liquor, (NH₄)₂SO₄, K₂HPO₄, MgSO₄.7H₂O, CaCl₂.2H₂O and MnSO₄.H₂O as a culture medium and composed of following steps:
a. Bacterial Species:
choosing a proper sort of Bacillus subtilis isolates which is applicable to production of bactericide or soil conditioner;
b. Fermentation Tank:
implementing fermentation tanks of stirred aerated type or some other type supplying equivalently high oxygen intensity to cultivate Bacillus subtilis during a liquid fermentation treatment for supporting sufficient oxygen to aerobic Bacillus subtilis;
c. Culture Medium:
preparing the culture medium with the optimal composition range of starch varying from 5 to 40 g/L, protein varying from 3 to 24 g/L, molasses varying from 1 to 8 g/L, yeast powder varying from 1.5 to 12.0 g/L, corn steep liquor varying from 0.5 to 4.0 g/L, (NH₄)₂SO₄ varying from 0.3 to 2.4 g/L, K₂HPO₄ varying from 0.4 to 3.2 g/L, MgSO₄.7H₂O varying from 0.2 to 1.6 g/L, CaCl₂.2H₂O varying from 10 to 80 mg/L and MnSO₄.H₂O varying from 6 to 48 mg/L;
d. Fermentation Treatment:
operating a fermentation treatment of a culture solution containing said bacterial species and culture medium at 20˜40° C., pH6.0-8.0 and over 30% DO saturation;
e. Concentration:
demoisturizing the culture solution by method of vacuum concentration operated preferably below 0.5 atm and under 60° C.; more preferably under 0.1 atm and under 40° C., and most preferably under 0.01 atm and under 35° C.;
f. Liquid Preparation:
adding a proper amount of a proper additive to adjust a moisture content of the concentrated culture solution to reach a spore density with a predetermined product standard to obtain a liquid preparation which can be applied as bactericide or soil conditioner;
g. Spray Dryness:
completely dehydrating the concentrated culture solution obtained through foresaid vacuum concentration by using a spray dryer with an outlet air temperature of a spray nozzle thereof under 70° C. to ensure the activity of the spores;
h. Powdery Preparation: and
adding a proper amount of a proper carrier, adjuvant or thinner into the powder obtained in the spray dryness to reach the spore density with a predetermined product standard to obtain a powdery preparation which can be applied as bactericide or soil conditioner; and
i. Other Forms of Preparation:
derivatively processing the liquid or powdery preparation to obtain additional forms of preparation such as pastilles or emulsion.

2. A method as cited in claim 1, wherein the fermentation tanks of stirred aerated type for cultivating Bacillus subtilis can possess capacity varied from 50 liters to 50000 liters (50 tons).

3. A method as cited in claim 1, wherein the proper additive for the liquid preparation includes at least preservative and acid or alkaline liquid for modulating pH fluctuations.

4. A method as cited in claim 3, wherein the liquid preparation containing Bacillus subtilis is realized by adding a proper amount of water and acid or alkaline liquid into the concentrated culture solution to modulate the pH value to 7.0±0.5 and modulate the spore density to over 10⁹/ml.

5. A method as cited in claim 1, wherein the carrier, adjuvant or thinner for powdery preparation includes at least wood flour, clay powder and dispersing surfactant.

6. A method as cited in claim 5, wherein the powdery preparation containing Bacillus subtilis is realized by adding a proper amount of the clay powder into the concentrated and spray dried culture solution to modulate the spore density to over 10⁹/g.

7. A method as cited in claim 1, wherein the bactericide or soil conditioner can be applied to plants, soil and seed and presents excellent effect on control of bacterial wilt.
